(19) United States
(12) Patent Application Publication
(10) Pub. No.: US 2008/0160913 A1
(43) Pub. Date: Jul. 3, 2008

(54) Continental Size Single Frequency Network

(76) Inventor: Rares GARDUS, Bucharest (RO)

Correspondence Address: FITCH EVEN TABIN AND FLANNERY, 120 SOUTH LA SALLE STREET, SUITE 1600, CHICAGO, IL, 60603-3406, US

(21) Appl. No.: 11/617,905

(22) Filed: Dec. 29, 2006

(51) Int. Cl. H04B 7/14

(52) U.S. Cl. 455/18

(57) ABSTRACT

A single frequency network [100] includes a main central site [200] and a remote site [300]. The main central site [200] (a) generates a digital symbol based on an input source, (b) receives external reference information from a common source, (c) stores the digital symbol in a local memory buffer [215], (d) adds a time stamp to the digital symbol based on the external reference information, (e) transmits the digital symbol and the time stamp (f) generates an RF signal based on a modulation of a carrier by the digital symbol at a predetermined time according to the time stamp, and (g) broadcast the RF signal. The remote site [300] receives the digital symbol, determines the time stamp, generates the RF signal based on modulation of the carrier by the digital symbol at the predetermined time according to the time stamp, and broadcasts the RF signal.

### TECHNICAL FIELD

This invention relates generally to a Single Frequency Network (“SFN”) for broadcasting a digital signal over a large geographical area.

### BACKGROUND

An SFN is a broadcast network in which several transmitters simultaneously send the same signal over the same frequency channel. An aim of SFNs is to make an efficient utilization of the radio spectrum, allowing a higher number of radio and television programs than would be possible in a traditional Multi-Frequency Network (“MFN”) transmission. An SFN may also increase the coverage area and decrease the outage probability in comparison to an MFN, since the total received signal strength may increase for positions between the transmitters.

Existing single frequency technologies and implementations are based on the assumption (theoretically true) that if one delivers to identically-built digital modulators a common frequency reference and the same output, then the modulated digital output can be used for an SFN. A variety of equipment for SFNs that is usable for any type of digital broadcast is already available on the market. Each of these implementations uses various techniques for synchronizing the input signals for the modulators.

A major disadvantage of the current SFNs is that they are relatively complex and therefore expensive. Implementing an SFN today requires use of an SFN adapter as an intermediary between a digital service multiplexor and a modulator. This adapter can be integrated in the multiplexor or placed later in the stream and is used for synchronizing the digital input to the modulators. This type of approach does not, however, guarantee an exact digital output from the modulator because the digital modulation process utilizes mathematically calculated values that have a degree of error due to rounding up/down “glitches.” Normally, this is not a major problem for small SFNs, such as SFNs having two to four transmitter sites. This problem is magnified, however, in large SFNs and at a point in the coverage area where there are more than five or six possible receptions from difference transmission sites. Another major problem is size and scale, in terms of service area coverage for the existing SFNs.

Current SFNs include a main transmitter and several remote transmitters. The main transmitter performs all of the modulation and transmits the same radio frequency (“RF”) signal to each of the remote transmitters that subsequently broadcast the signal. A problem arises, however, in the event that the remote transmitters are different distances from the main transmitter. If one of the remote transmitters is closer to the main transmitter than the other remote transmitters, the signal will be received by the closer remote transmitter and broadcast prior to that of the other remote transmitters, possibly resulting in equalizer errors in geographical areas receiving the broadcast signal from multiple remote transmitters at different times. Correcting for the distance variations can be complex. It may be possible to ensure that the signal is received at the remote sites at substantially the same time by utilizing wires of exactly the same length between the main transmitter and each of the remote transmitters. For the closer remote transmitters the additional wiring may be looped underneath the ground. However, in the event that one of the remote transmitters is two kilometers closer to the main transmitter than the other remote transmitters, for example, two kilometers of wiring would have to be looped underneath the ground. This process is therefore seen to be potentially costly, complex, and would require precise lengths of wiring in this case, of RF transport.

In current systems using input synchronizations procedures, but not RF transport, a clocking reference signal is sent from the main transmitter to the remote transmitters. However, because the clocking signal is sent from the main transmitter, it is not possible to perform fine and virtual arbitrary adjustments in time to the signal at any of the remote sites. For example, it would not be possible to make a one usec shift on a ten usec clock according to current systems. In these systems synchronizing relies on the input clock therefore adjustments are possible only in steps equal with this clock. This works well in the actual small size SFNs.

Current systems often include a main transmitter to broadcast a powerful signal. Broadcast signals from current systems can reach far beyond their intended destination in the event of abnormal propagation (e.g., because of atmospheric conditions). This can result in interference with other stations far away broadcasting on the same frequency. Another major issue is for coordination between sites using the same frequencies. In case of low power transmitters this coordination problem is significantly reduced or may disappear entirely.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a continental single frequency network according to at least one embodiment of the invention;

FIG. 2 illustrates a main site according to at least one embodiment of the invention; and

FIG. 3 illustrates a remote site according to at least one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION

According to various embodiments described below, an SFN is provided that can broadcast to a large geographical area via a main site and a set of remote sites, each of which includes a transmitter to broadcast a signal. The main goal is that all sites (including the main site) will transmit exactly at the same time the same signal. The whole processing is done in the main site of a Continental Size Single Frequency Network (“CSFN”) so “digital symbols” are generated for a guaranteed exact output. As referred to herein, “digital symbol” means a sample of the signal before digital-to-analog conversion. The main site generates the digital symbols according to an external clock reference such as a Global Positioning System (“GPS”) or any other timed references available to all sites simultaneously. The digital symbols are transmitted from the main site to the remote sites. The reference clock information is utilized by the main site to provide time stamps to the digital symbols. The time stamps are utilized to indicate the precise time at which each of the digital symbols is to be broadcast by the sites.

The digital symbols are transmitted and stored in a memory buffer at each of the remote sites. When the symbols are received and the signal is to be broadcast at the remote sites, the symbols are extracted from the memory buffers at the remote sites. For the remote sites farthest (in distance) from the main site, the symbol to be transmitted at a particular time is in the top of the memory buffer (i.e., closer to the real time). For remote sites that are closer to the main site, the symbol will be located lower down in the memory buffer, such as in the middle of the memory buffer (related to real time). For remote sites very close to the main site the symbols will be located near the bottom of the memory buffer (related to real time). The reason for the different location of the symbols to be broadcast is because it takes longer for the symbol to arrive at the farthest remote site. By the time the symbol is received and stored in the buffer of the remote site farthest away, additional more recently transmitted symbols will have been received by the remote sites located closer to the main site. Accordingly, because the main site and the various remote sites are transmitting on the same frequency, it is necessary to transmit the same signal at the same time by each of the remote sites and the main site. The location in the various memory buffers of the symbols to be broadcast varies for the memory buffers is therefore based on the location of each particular remote site relative to the main site. The time stamp that is included in the transmitted signal is utilized by the remote sites to determine when to broadcast a symbol, as well as which symbol is to be broadcast.

The signals broadcast by the sites are received by receivers within the coverage area. Radio waves reflect on the obstacles they meet. At the receiver side, the receiver receives the direct wave (if in line of sight) from several sites and the reflected waves at the same time. This leads to canceled power at certain frequencies and also a time difference between the different received components that makes the received signal spread in the time domain. A consequence on the system is harmful and leads to decreased performances (e.g., transmission errors). In order to reduce this effect the receiver, an equalizer is utilized to counteract these faults. The equalizer is common to digital receivers in any standard and domain. A path length difference of 15 kilometers represents a time delay of 50 microseconds. For a common equalizer range between 10 and 25 usec, the receiver will accept signals with a time difference of three to seven kilometers. The energy per bit of noise received is increased because the energy in the received signals from the various sites is cumulative (for certain standards such as Digital Video Broadcasting-Terrestrial (“DVB-T”)). Accordingly, the receiver experiences an improved reception than would be possible if a single large transmitter were utilized, as is done according to current systems.

The CSFN main site will utilize a level of power that is far less than that used by transmitters of current systems. The CSFN main site would probably have no transmitter at all, and virtually all sites are low power remote sites. For example, current transmitters often transmit at 100 kilowatts Effective Radiated Power (“ERP”). The transmitter of the main site according to at least one embodiment of the present invention may transmit at about 10 kilowatts ERP, or 1/10 that of the transmitters that are currently being used. The use of a low power set of remote sites is less expensive than current broadcast systems which typically include one large main transmitter that transmits signals at a very high energy level located on expensive sites (e.g., rented or operated).

The digital symbols are transmitted from the main site to the remote sites before conversion to an analog RF signal. This varies from current SFNs which only transmit fully modulated signals to remote sites or use modulators with synchronized inputs. By converting to analog RF on each remote site using clock information provided by an external reference (available to the entire CSFN), fine adjustments can be made. These adjustments can be made with a precision below the symbol rate of the digital transmission.

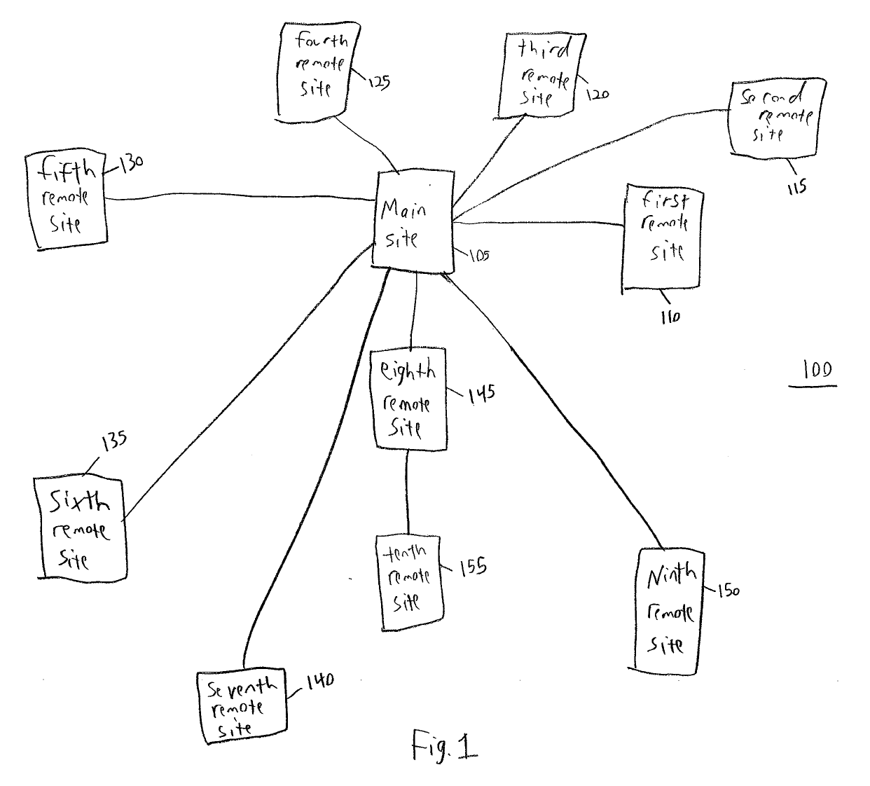

FIG. 1 illustrates a continental single frequency network (“SFN”) 100 according to at least one embodiment of the invention. The continental SFN 100 may be implemented across a large geographical area, such as an entire continent. The continental SFN 100 includes a main (or “central”) site 105, a first remote site 110, a second remote site 115, a third remote site 120, a fourth remote site 125, a fifth remote site 130, a sixth remote site 135, a seventh remote site 140, an eight remote site 145, a ninth remote site 150, and a tenth remote site 155. The remote sites may be spaced 25 kilometers from the closest adjacent remote sites and/or the main site. Based on the geography between the remote sites, they may be placed closer together than 25 kilometers. For example, in a mountainous area or in an urban area having a large number of tall buildings it may be necessary to position the remote sites 15 kilometers apart to ensure that the entire surrounding area can be reached by a broadcast wireless signal. It should be appreciated that although ten remote sites are shown in FIG. 1, in some embodiments more or fewer than ten remote sites may be utilized this is in respect to the size of the network (in very large networks the actual number of sites could go in range of tenths of thousands).

As shown in FIG. 1, each of the remote sites is in communication with the main site 105. A remote site, such as the first remote site 110, may be in direct communication with the main site. However, a direct connection to the main site 105 is not required, and an indirect connection may be instead be utilized to limit complexity. For example, as shown, the tenth remote site 155 is in indirect communication with the main site 105. That is, the tenth remote site 155 is in direct communication with the eighth remote site 145, which is, in turn, in direct communication with the main site 105. So configured, communications between the tenth remote site 155 and the main site 105 can be repeated or otherwise relayed via the eighth remote site 145.

The main site 105 and each of the remote sites broadcast the same signal at the same time and at the same frequency. The main site 105 generates a series of digital symbols containing the signal to be broadcast. The main site 105 stores the digital symbols in its own internal buffer and transmits copies of the digital symbols along with a time stamp to the remote sites. The time stamp is indicative of the time at which a particular digital symbol is to be broadcast by both the main site 105 and each of the remote sites. The main site 105 and each of the remote sites acquire a clock signal from an external reference, such as GPS or a purpose-build and broadcasted satellite signal. At the appropriate time indicated by the time stamp, the digital symbols are broadcast throughout the network. By utilizing a common external clock reference, the continental SFN 100 ensures that the digital symbols are broadcast throughout the network at the precise time indicated by the time stamp.

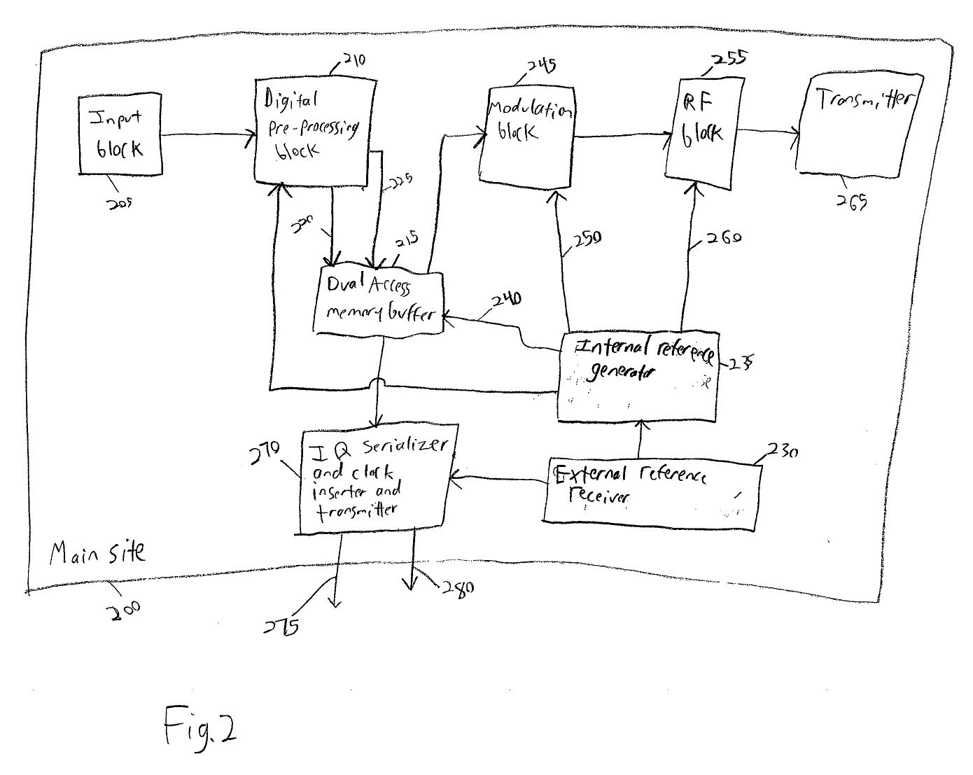

FIG. 2 illustrates a main site 200 according to at least one embodiment of the invention. The main site 200 is generally responsible for generating the digital symbols to be broadcast and transmitting them to the other remote sites along with the time stamp to ensure that the remote sites know when to broadcast the digital symbols. The main site 200 includes an input block 205. The input block 205 either receives data or other information to be broadcast, or it generates such data or other information itself. The input block 205 may perform Moving Picture Experts Group (“MPEG”) coding (for desired service), multiplexing, scrambling, and service insertion on the data. The input block 205 outputs a stream of data, in form of packets, in form and standards related to each individual standard used, to a digital pre-processing block 210. The digital pre-processing block 210 may perform forward error correction (“FEC”), formatting, and filtering on the packet. The digital pre-processing block implements the network required standard of transmission. This means that in respect to the local standard and use (TV, radio, and so forth), this is the block that creates the digital signal needed to be broadcasted in the transmitters. The final step is conversion from digital to analog RF signal. If the standard implemented by the CSFN uses a common digital modulator, this is to be done by IQ modulation to generate in-phase (“I”) and a quadrature (“Q”) portions. In its various forms, IQ modulation is an efficient way to transfer information, and it also works well with digital formats. An IQ modulator can actually create digital modulated signals such as Quadrature Phase-shift Keying (“QPSK”) modulation, 8-Quadrature Amplitude Modulation (“8QAM”), 32QAM, and Binary Phase-Shift Keying (“BPSK”).

The input block 205 and the digital pre-processing block 210 may be sourced from the existing market or re-used from the actual sites. This means that existing encoders, multiplexors, scramblers and other digital processing equipment can be used with a CSFN with no alteration and can be directly plugged into the system. The input block 205 may perform signal encoding, multiplexing, scrambling, and value added services (such as Electronic Program Guide (“EPG”) or Internet Protocol (“IP”) data insertion). The digital pre-processing block 210 may be contained within a modulator utilized to implement DVB-T or handheld (“-H”); Advanced Television Systems Committee (“ATSC”), or Digital Audio Broadcasting (“DAB”)-T or -H.

An IQ clock write is transmitted from the digital pre-processing block 210 to a dual-access memory buffer 215 via line 220. The user sets this clock according to the actual data rate in the signal. The digital pre-processing block 210 also transmits the IQ data to the dual access memory buffer 215 via line 225. The IQ data remains in the dual access memory buffer 215 until it is time to broadcast the signal. This acts like a buffer for accommodating the whole chain needed in the network, regardless of the size (in number and kilometers covered). As discussed above, the time at which the signal is broadcast is pre-determined so that the main site and remote sites broadcast the same signal at the same time.

An external reference receiver 230 receives common clock, frequency, and phase information from an external source such as GPS or a dedicated satellite transmission available to all sites. The reference clocking information is provided to an internal reference generator 235 which generates clock and frequency signals to be utilized by the main site 200. These clocks will be common to the entire network and are user selected in relation with each network standard, rules and rates.

The internal reference generator 235 transmits an IQ clock signal to the dual access memory buffer 215 via line 240. The internal reference generator 235 transmits a frequency reference to a modulation block 245 via line 250 and an up-converter frequency reference to a Radio Frequency (“RF”) block 255 via line 260. The modulation block 245 performs a modulation function on IQ data that has been stored in the dual access memory buffer 215 and then transferred to the modulation block 245. The modulation block 245 performs any suitable type of modulation, such as Quadrature Amplitude Modulation (“QAM”), Quadrature Phase-shift Keying (“QPSK”) modulation, Binary Phase Shift Keying (“BPSW”), Amplitude Shift Keying (“ASK”), Frequency Shift Keying (“FSK”), or Vestigial Sideband Modulation (“VSB”). The modulation block 245 also performs digital to analog conversion.

The modulation block 245 should not be seen as a modulator. Quadrature modulation is included with the analog carrier, so the modulation block performs digital to analog conversion. Depending of the standard used in the network the block called modulation block 245 is understood as being a converter to analog carrier signals. The actual implementation of the IQ digital signal will follow the standard used in the network. The RF block 255 performs an up-conversion and amplification of the modulated signal and outputs the resultant signal to a transmitter 265 that broadcasts the signal. For added stability it is better to have a “direct to channel” modulation in the modulation block 245. This RF block 255 is depicted here for an easy understanding and also for systems which are to be upgraded from existing equipment to this technology. The IQ data stored in the dual access memory buffer 215 is also sent to an IQ serializer and clock inserter and transmitter block 270 that serves to serialize the IQ data, add a time stamp, and transmit the IQ data to at least one remote site. The IQ data may be sent from the main site 105 via a primary link 275 and a redundant link 280. In some embodiments, the primary link 275 may be terrestrial and the redundant link 280 may be a satellite link.

Accordingly, the IQ data is stored at the main site 200 and transmitted to the remote site and is subsequently modulated at both the main site 200 and the remote site. This differs from current systems that perform modulation one time, at the main site, and then transmit the fully modulated RF signal to the remote sites for broadcast.

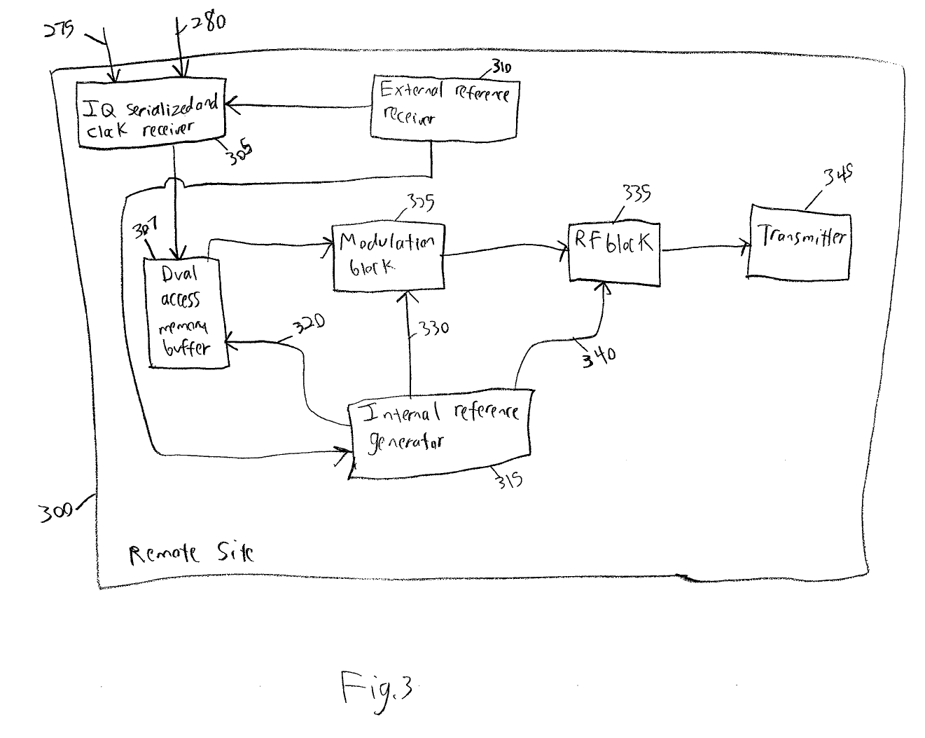

The IQ digital signal generated by the digital pre-processing block 210 is normally fed directly to the modulation block 245 having any common modulator. The modulation block 245 may comprise an Inverse Fast Fourier Transform (“iFFT”) modulator when Coded Orthogonal Frequency Division Multiplexing (“COFDM”) is implemented. After any processing in time, the IQ signal is serialized and stored in the dual access memory buffer 215 as IQ data written according to the IQ clock signal provided at line 240 by the internal reference generator 235. The clocking signal generated by the internal reference generator 235 must be synchronized with the clocking signal received by the external reference receiver 230 so that the IQ data can subsequently be synchronized as a time slice and perfectly reproduced. The internal reference generator 235 is utilized to generate the requested clock and references in phase and frequencies for the read signals used to place the symbols in the exact synchronous position in time and frequency/phase at the main site 200 as well as at remote sites. With respect to user data (including, e.g., the standard used and data rate), central (main) site clocks must be generated accordingly. The internal reference generator 235 will inform the remote sites, via links 275 and 280, about all clocks (frequency, phase, time stamp) that must be used to retrieve a coherent signal to the output from the buffer. The External Reference Receiver consists of the same hardware in all sites, and an Internal Reference Generator from remote sites (denoted by reference 315 discussed below with respect to FIG. 3) generate clocks, as the Internal Reference Generator 235 sets clocks for the whole network.

The external reference receiver 230 can be sourced from a GPS receiver, Galileo receiver, or a signal received from a geo-stationary satellite on which the operator for the continental SFN 100 is transmitting a signal containing a reference signal and time digital clock in any suitable manner. This signal must be available to the entire continental SFN 100 in order for the remote sites to work in synchronization with the main site 200 and each other.

The dual access memory buffer 215 must be larger than the maximum continental SFN 100 size in terms of remote site link delays such as, for example 1.5 times. The remote site link delays are caused by the physical distance between the remote sites and the main site 200 and the differences in the amount of time required for the signal traveling on links 275 and 280 to reach each of the remote sites. The IQ data is fed to the modulation block 245 in synchronization and delivered to the IQ serializer and clock inserter and transmitter 270. For example, for a continental-size SFN (e.g., from Alaska to California, Florida, and Maine), the dual access memory buffer 215 accommodates about two seconds of delay (even if the IQ data link is provided to a geo-stationary satellite). The IQ serializer and clock inserter and transmitter 270 encapsulates the IQ data in a time stamped mode, as discussed above, with an accuracy of more than 10 milliseconds which can be transmitted to the remote sites over the primary link 275 and the redundant link 280 via existing technologies such as Asynchronous Serial Interface (“ASI”) or any other like IP encapsulated data. The external reference receiver 230 ensures a perfect synchronization in the remote sites so that the actual RF signal transmitted in the air will be as identical and synchronous as possible.

FIG. 3 illustrates a remote site 300 according to at least one embodiment of the invention. A primary link 275 and a redundant link 280 provide serialized IQ data to an IQ serialized and clock receiver 305 from the main site 200 shown in FIG. 2. In some embodiments, the primary link 275 and redundant link 280 are in direct communication with the main site 200. In other embodiments, the primary link 275 and redundant link 280 are in indirect communication with the main site 200. The serialized IQ data is stored in a dual access memory buffer 307 after being received by the IQ serialized and clock receiver 305.

The remote site 300 includes an external reference receiver 310 to receive the common clock, frequency, and phase information from an external source such as GPS or a dedicated satellite transmission. The external reference receiver provides a clock signal to the IQ serialized and clock receiver 305 and to an internal reference generator 315. The internal reference generator 315 generates clock and frequency signals to be utilized by the remote site 300. The internal reference generator 315 transmits an IQ read clock signal to the dual access memory buffer 307 via line 320. The internal reference generator 315 transmits a frequency reference to a modulation block 325 via line 330 and an up-converter frequency reference to an RF block 335 via line 340. The modulation block 325 performs a modulation function on byte packets that have been stored in the dual access memory buffer 307 and then transferred to the modulation block 325. The modulation block 325 performs any suitable type of modulation, such as QAM or QPSK modulation. The modulation block 325 also performs digital to analog conversion, as discussed above. The RF block 335 performs an up-conversion amplification of the modulated signal and outputs the resultant signal to a transmitter 345 that broadcasts the signal.

The combination of the main site 200 and multiple remote sites such as the remote site 300 shown in FIG. 3 provides numerous advantages in terms of geographical coverage. In current transmission systems, a large tower is utilized to transmit a strong signal at a power of, for example, 100 kilowatts ERP. Despite the strong signal, receivers whose line-of-sight to the transmitter is blocked by the presence of a building or a geographical formation such as a mountain may not receive the signal in a level and quality enough to be useful. Most of the energy of the signal is received by receivers within a certain distance of the transmitter via reflected waves.

According to the main site 200 and the remote site 300 discussed above, bits representing the IQ signals for any type of modulation are time stamped and serialized. This is done by the common reference in all sites such as GPS, Galileo (the European Union position satellite system), a purpose-built and transmitted signal on a geo-stationary satellite containing a frequency reference and time synchronization, or any other reference available for all sites in the SFN. The serialized bits are transmitted via the different links to the remote sites where the same frequency and time reference is utilized to ensure exact digital modulation reproduction.

A low power SFN increases the coverage quality in urban area if the distance between sites is less than the receivers' equalizer range translated in kilometers. A CSFN will use many low power sites with serious advantages. There is no need to use high towers or buildings (usually very expensive to be rented) or very remote locations, now a skilled person can place transmitters sites in sub-urban location with small in height towers and using low power transmitters.

Synchronization after the digital symbol creation ensures a 100% identity is SFNs and also a very good signal to noise ratio for a low power broadcasting method. This type of synchronization can be used with virtually no limitations on size. A person of skill in the art would understand, however, that careful planning of the location of the remote sites must be achieved in order to achieve the good signal to noise ratio in any position in the coverage area.

This type of continental SFN 100 as discussed herein can even be utilized in a very strict service area because a low power SFN 100 can “hairline” limit a service area. In other words, for example, the continental SFN can precisely limit the signal to the designated service area. This is particularly valuable in a region having bordering countries or territories where people speak different languages. For example, the SFN could transmit through the United States without transmitting the signal across the border to Mexico, unlike current broadcast systems. Another very significant benefit of the CSFN is that no co-ordination is needed between networks using same frequency because of the low power and effective height of the sites.

According to various embodiments described above, an SFN is provided that can broadcast to a large geographical area via a main site and a set of remote sites, each of which includes a transmitter to broadcast a signal. Digital symbols are generated at the main site of the SFN. The main site generates the digital symbols according to an external clock reference. The digital symbols are transmitted from the main site to the remote sites. The reference clock information is utilized by the main site to provide time stamps to the digital symbols. The time stamps are utilized to indicate the precise time at which each of the digital symbols is to be broadcast by the main site and the remote sites.

The digital symbols are transmitted and stored in a memory buffer at each of the remote sites. When the symbols are received and the signal is to be broadcast at the remote sites, the symbols are extracted from the memory buffers at the remote sites. For the remote sites farthest (in distance) from the main site, the symbol to be transmitted at a particular time is in the top of the memory buffer (i.e., closer to the real time). For remote sites that are closer to the main site, the symbol will in located lower down in the memory buffer, such as in the middle of the memory buffer. For remote sites very close to the main site the symbols will be located near the bottom of the memory buffer (i.e., farthest from the real time). The time stamp that is included in the transmitted signal is utilized by the remote sites to determine when to broadcast a symbol, as well as which symbol is to be broadcast.

The symbols broadcast by the main site and the remote sites are received by receivers within the coverage area. The digital receivers utilize an equalizer. An easy to understand but simplified model is as follows: according to the equalizer range, the receivers stop and listen for which symbols are coming during a set time period. For a time interval, such as between 10 and 25 usec, digital symbols are gathered that are received. The energy per bit over noise received is increased because the energy in the received signals from the various sites is cumulative. Accordingly, the receiver experiences an improved reception than would be possible if a single large transmitter were utilized, as is done according to current systems.

The main site may utilize a level of power that is far less than that used by transmitters of current systems. For example, current transmitters often transmit at 100 kilowatts ERP of power. The transmitter of the main site according to at least one embodiment of the present invention may transmit at about 10 kilowatts, or 1/10 that of the transmitters that are currently being used. The use of a less powerful main site and a set of remote sites is less expensive than current broadcast systems which typically include one large main transmitter that transmits signals at a very high energy level.

Another benefit of utilizing less power in the main site is that certain abnormal propagation issues are mitigated.

Those skilled in the art will recognize and appreciate that these teachings can be applied in various ways and are readily leveraged in a variety of application settings. It will also be understood and appreciated that these teachings can be relatively economically facilitated and are highly scalable in practice.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A single frequency network, comprising:
a main central site to generate a digital symbol based on an input source, receive external reference information from a common source, store the digital symbol in a local memory buffer, add a time stamp to the digital symbol based on the external reference information, transmit the digital symbol and the time stamp, modulate a carrier using the digital symbol, generate a radio frequency (“RF”) signal based on a modulation of the digital symbol, and broadcast the RF signal at a predetermined time according to the time stamp; and
at least one remote site to receive the digital symbol, determine the time stamp, modulate the carrier using the digital symbol, generate the RF signal based on a modulation of the digital symbol, and broadcast the RF signal at the predetermined time according to the time stamp.

2. The single frequency network of claim 1, wherein a digital pre-processing block of the main central site performs digital pre-processing on an input signal to generate the digital symbol, wherein the digital pre-processing comprises performing IQ modulation on the input signal according with user data settings comprising at least one of: a standard and a rate.

3. The single frequency network of claim 1, wherein the external reference information comprises at least one of: clocking information, frequency information, and phase information.

4. The single frequency network of claim 3, wherein the common source comprises at least one of: a Global Positioning System (“GPS”) provider, Galileo™, and a dedicated geo-stationary satellite transmission.

5. The single frequency network of claim 1, wherein the main central site and the at least one remote site modulate each comprise a modulator to modulate the carrier using the digital symbol according to one of Quadrature Amplitude Modulation (“QAM”), Quadrature Phase-shift Keying (“QPSK”) modulation, Binary Phase Shift Keying (“BPSK”), Amplitude Shift Keying (“ASK”), Frequency Shift Keying (“FSK”), and Vestigial Sideband Modulation (“VSB”)

6. The single frequency network of claim 1, wherein the main central site comprises a transmitter to transmit the digital symbol and the time stamp to the at least one remote site via at least one of a terrestrial link and a satellite link.

7. A method of implementing a single frequency network, comprising:
generating a digital symbol based on an input source;
receiving, by a main central site, external reference information from a common source;
storing the digital symbol in a local memory buffer;
adding a time stamp to the digital symbol based on the external reference information;
transmitting the digital symbol and the time stamp;
modulating a carrier using the digital symbol at a predetermined time according to the time stamp;
generating a radio frequency (“RF”) signal based on the modulated carrier;
broadcasting, by the main central site, the RF signal receiving the digital symbol from the main central site, by at least one remote site;
performing, by the at least one remote site: a determination of the time stamp, a modulation of the digital symbol, a generation of the RF signal based on the modulation of the carrier using the digital symbol at the predetermined time according to the time stamp, and a broadcasting of the RF signal.

8. The method of claim 7, further comprising performing digital pre-processing on an input signal from the input source to generate the digital symbol, wherein the digital pre-processing comprises performing digital modulation on the input signal using in-phase and in-quadrature (“IQ”) carriers.

9. The method of claim 7, wherein the external reference information comprises at least one of: clocking information, frequency information, and phase information.

10. The method of claim 9, wherein the common source comprises at least one of: a Global Positioning System (“GPS”) provider, Galileo™, and a dedicated geo-stationary satellite transmission.

11. The method of claim 7, further comprising modulating the digital symbol according to one of Quadrature Amplitude Modulation (“QAM”), Quadrature Phase-shift Keying (“QPSK”) modulation, Binary Phase Shift Keying (“BPSK”), Amplitude Shift Keying (“ASK”), Frequency Shift Keying (“FSK”) and Vestigial Sideband Modulation (“VSB”).

12. The method of claim 7, further comprising transmitting the digital symbol and the time stamp to the at least one remote site via at least one of a terrestrial link and a satellite link.

13. A main central site for a single frequency network, comprising:
a digital pre-processing block to generate a digital symbol based on an input source;
an external reference receiver to receive external reference information from a common source;
a local memory buffer to store the digital symbol;
a clock inserter and transmitter to add a time stamp to the digital symbol based on the external reference information and transmit the digital symbol and the time stamp, wherein the digital symbol and the time stamp are transmitted to at least one remote site;
a modulator to modulate a carrier with the digital symbol at a predetermined time according to the time stamp;
a Radio Frequency (“RF”) block to generate an RF signal to be broadcasted;
a transmitter to broadcast the RF signal; and
wherein the at least one remote site is adapted to determine the time stamp, modulate the carrier with the digital symbol at the predetermined time according to the time stamp, generate the RF signal symbol, and broadcast the RF signal.

14. The main central site of claim 13, wherein the digital pre-processing block of the main central site performs digital pre-processing on an input signal to generate the digital symbol, wherein the digital pre-processing comprises performing digital modulation for the input signal.

15. The main central site of claim 13, wherein the external reference information comprises at least one of: clocking information, frequency information, and phase information.

16. The main central site of claim 14, wherein the common source comprises at least one of: a Global Positioning System (“GPS”) provider, Galileo™, and a dedicated geo-stationary satellite transmission.

17. The main central site of claim 13, wherein the modulator modulates the digital symbol according to one of Quadrature Amplitude Modulation (“QAM”), Quadrature Phase-shift Keying (“QPSK”) modulation, Binary Phase Shift Keying (“BPSK”), Amplitude Shift Keying (“ASK”), Frequency Shift Keying (“FSK”) and Vestigial Sideband Modulation (“VSB”).

18. The main central site of claim 13, further comprising a second transmitter to transmit the digital symbol and the time stamp to the at least one remote site via at least one of a terrestrial link and a satellite link.
